(19) United States
(12) Patent Application Publication
(10) Pub. No.: US 2002/0172406 A1
(43) Pub. Date: Nov. 21, 2002

(54) Image processing Method for fitness estimation of a 3D mesh model mapped onto a 3D surface of an object

(76) Inventors: Jean-Michel Rouet, Paris (FR); Maxim Fradkin, Paris (FR); Sherif Makram-Ebeid, Dampierre (FR)

Correspondence Address: Thomas M. Lundin, Esq., Philips Medical Systems (Cleveland), Inc., 595 Miner Road, Cleveland, OH, 44143, US

(21) Appl. No.: 10/109,371

(22) Filed: Mar. 28, 2002

(30) Foreign Application Priority Data
Mar. 29, 2001 (EP) 01400817.1

(51) Int. Cl. G06K 9/00

(52) U.S. Cl. 382/128

(57) ABSTRACT

The invention relates to an image processing method for the segmentation of a three dimensional object in a three dimensional image including an operation of mapping a three dimensional mesh model onto said three dimensional object comprising steps of acquiring a tri-dimensional image of an object of interest to be segmented; generating a Mesh Model, formed of cells that can be decomposed into triangles; deforming the Mesh Model in order to map said Mesh Model onto said object of interest; estimating the gradient flow value or a gradient derived measure level of the gradient vector field that passes through the cell surface area of a predetermined number of cells of the Mesh Model; and assessing the goodness of fitness of the Mesh Model according to the proportion of cells for which the gradient flow value or gradient derived measure level reaches at least a predetermined level called fitness threshold. The gradient flow value or gradient derived measure level is color coded to display a color coded image of the Mesh Model for visual assessment of the goodness of fitness.

### FIELD OF THE INVENTION

The invention relates to an image processing method for the segmentation of a three dimensional object in a three dimensional image comprising an operation of mapping a three dimensional mesh model onto said three dimensional object. The invention also relates to an image processing method for displaying the segmented three dimensional object mapped with the three dimensional mesh model with visual indications of the fitness of said mesh model with respect to said object. The invention further relates to medical imaging apparatus or systems and to program products for processing medical three dimensional images produced by those apparatus or systems, for the segmentation of objects that are body organs in order to study or detect organ pathologies.

The invention finds a particular application in the field of medical imaging methods, program products and apparatus or systems.

### BACKGROUND OF THE INVENTION

A technique of modelization of a 3-D object is already disclosed by H. DELINGETTE in the publication entitled “Simplex Meshes: a General Representation for 3D shape Reconstruction” in the “processing of the International Conference on Computer Vision and Pattern Recognition (CVPR'94), 20-24 June 1994, Seattle, USA”. In this paper, a physically based approach for recovering three-dimensional objects is presented. This approach is based on the geometry of “Simplex Meshes”. Elastic behavior of the meshes is modeled by local stabilizing functions controlling the mean curvature through the simplex angle extracted at each vertex (node of the mesh). Those functions are viewpoint-invariant, intrinsic and scale-sensitive. Unlike deformable surfaces defined on regular grids, Simplex Meshes are very adaptive structures. A refinement process for increasing the mesh resolution at highly curved or inaccurate parts is also disclosed. Operations for connecting Simplex Meshes in order to recover complex models may be performed using parts having simpler shapes.

A Simplex Mesh has constant vertex connectivity. For representing 3-D surfaces, Simplex Meshes, which are called 2-Simplex Meshes, where each vertex is connected to three neighboring vertices, are used. The structure of a Simplex Mesh is dual to the structure of a triangulation as illustrated by the FIG. 1 of the cited publication. It can represent all types of orientable surface. The contour on a Simplex Mesh is defined as a closed polygonal chain consisting of neighboring vertices on the Simplex Mesh. The contour is restricted to not intersect itself, as far as possible. Contours are deformable models and are handled in independently of the Simplex Mesh where they are embedded. Four independent transformations are defined for achieving the whole range of possible mesh transformations. They consist in inserting or deleting edges in a face. The description of the Simplex Mesh also comprises the definition of a Simplex Angle that generalized the angle used in planar geometry; and the definition of metric parameters that describe how the vertex is located with respect to its three neighbors. The dynamic of each vertex is given by a Newtonian law of motion. The deformation implies a force that constrains the shape to be smooth and a force that constrains the mesh to be close to the 3-D object. Internal forces determine the response of a physically based model to external constraints. The internal forces are expressed so that they be intrinsic viewpoint invariant and scale dependant. Similar types of constraints hold for contours.

Hence, the cited publication provides a simple model for representing a given 3-D object. It defines the forces to be applied in order to reshape and adjust the model onto the 3-D object of interest. The “Simplex Mesh technique” is a robust segmentation method.

### SUMMARY OF THE INVENTION

It is an object of the present invention to propose an image processing method for estimating the fitness of a three dimensional mesh model mapped onto a three dimensional surface of an object represented in a gray level image and for displaying quantified and visual indications of the fitness of such a mesh model mapped onto said object surface, in a coded manner, preferably in a color coded manner. The three dimensional surface of the three dimensional object of interest is registered in a three dimensional gray level image. The three dimensional mesh model is mapped onto the three dimensional surface according to the mesh model technique for fitting at best said surface. In order to permit a user to appreciate the fitness of the mesh model with respect to the object surface, the fitness is estimated for three-dimensional cells of the mesh model. Then, said cells of the mesh model are colored according to a code of colors that permits of quantifying the cell fitness with respect to the corresponding zone of the three dimensional object. It is particularly an object of the invention to apply this method to the segmentation of three dimensional images of body organs.

The proposed image processing method is claimed in claim 1.

The invention also relates to a medical diagnostic imaging apparatus having 3-D image processing means. The medical imaging apparatus may be an X-ray medical examination apparatus or any other 3-D medical imaging apparatus. The invention further relates to a program product or a program package for carrying out the method.

### BRIEF DESCRIPTION OF THE DRAWINGS

The invention is described hereafter in detail in reference to the following diagrammatic drawings, wherein:

FIG. 1A represents an object of interest (a cube) and FIG. 1B represents a Simplex Mesh Model (a sphere) for segmenting this object using the Simplex Mesh technique;

FIG. 2A represents the simplex mesh model in a first phase of fitting the object of interest and FIG. 2B in a second phase of fitting the object of interest;

FIG. 3A represents the simplex mesh model in said first phase of fitting the object and FIG. 3B represents a color coded image (in black and white) of the simplex mesh model for estimation of the fitness with respect to the object of interest, in said first phase;

FIG. 4A represents the simplex mesh model in said second phase of fitting the object of interest and FIG. 4B represents a color coded image (in black and white) of the simplex mesh model for estimation of the fitness with respect to the object of interest, in said second phase;

FIG. 5A illustrates an elementary surface and vector orientations for flow computation;

FIG. 5B is a 2D representation of a real data contour and simplex cells to follow its local shape;

FIG. 5C illustrates the integration along a triangle using a parallelogram decomposition;

FIG. 6 illustrates an apparatus having a system for carrying out the image processing method.

### DESCRIPTION OF THE PREFERRED EMBODIMENTS

The invention relates to an image processing method to be applied for example to a three dimensional digital image represented in gray levels. The image may represent the noisy three dimensional surface of an organ called object of interest. In order to provide the user with a better view of the object of interest, for instance with respect to the background, this object is segmented. The segmented image permits the user of better studying or detecting abnormalities or diseases of the organ. The present image processing method comprises several steps:

1) Acquisition of the 3-D Digital Image of the Object of Interest.

The way the three dimensional image is acquired is not part of the invention. The segmentation method could be applied to three dimensional digital images of organs that can be acquired by ultrasound systems or X-ray apparatus or by other systems known of those skilled in the art. A three dimensional object is illustrated in FIG. 1A. In this example, this object is a cube C. This cubic surface has been chosen in order to demonstrate that the method may be applied to a great number of different and complex surfaces. After the acquisition of the three dimensional image representing the three dimensional object of interest, said image is segmented. The segmentation technique that has been previously described in relation to the publication above-cited as the state of the art is used because it is robust and gives excellent results. It is an iterative method that permits of representing the object of interest using the discrete model called Simplex Mesh Model.

2) Generation of the Discrete Model Called Simplex Mesh Model.

A three dimensional digital Simplex Mesh Model is generated as illustrated by FIG. 1B. In the present case, it is a simple sphere MO formed by a set of small three dimensional discrete curved faces F0, F1, F2, . . . called cells, which are linked by their boundaries called the edges of the Mesh Model, and which have common nodes called the vertices of the Mesh Model. The segmentation operation consists in mapping the three dimensional Simplex Mesh Model M0 of FIG. 1B onto the three dimensional object of interest C of FIG. 1A, in this example the cube. The cube surface segmentation implies a difficult geometry for the three dimensional Simplex Mesh Model because said cube surface has sharp corners.

A three dimensional Simplex Mesh Model such as M0 has constant vertex connectivity. As a matter of fact, a three dimensional surface is represented using the three dimensional Simplex Mesh Cells F0, F1, F2, . . . , where each given vertex is connected to three neighboring vertices. By neighbor vertex, it must be understood a vertex of a given cell that constitutes the second extremity of an edge of said cell starting at said given vertex. So, each given vertex is common to three Cells, hence is common to three angles and is the starting point of three edges. A Simplex Mesh Model such as M0 can represent all types of three dimensional surfaces using Mesh Transformations. Four independent transformations are defined for achieving the whole range of possible Mesh Transformations. They consist in inserting or in deleting vertices (nodes) in a cell; in defining angles in the cell; and in defining metric parameters that describe how the vertex is located with respect to its three neighbors. The dynamic of each vertex is given by a law of motion. The deformation implies an internal force that constrains the shape of the Simplex Mesh Model to be smooth and an external force that constrains the three dimensional Simplex Mesh Model to be close to the three dimensional object surface, in this example the surface C. The elastic behavior of the meshes is modeled by local stabilizing functions controlling the mean curvature through the simplex angle extracted at each vertex (node of the mesh). Those functions are viewpoint-invariant, intrinsic and scale-sensitive. It results that this Simplex Mesh Model is a very adaptive structure. Increasing the mesh resolution is performed by increasing the number of cells in zones showing highly curved or inaccurate parts. Recovering complex shapes may be performed by connecting two or several parts of Simplex Mesh Models having simple shapes.

The definition of the forces to be applied in order to reshape and adjust the model onto the 3-D object of interest are those that are described in the publication by H. DELINGETTE cited as the state of the art.

3) Segmentation of the 3-D Digital Images of the Sequence.

This segmentation operation consists in deforming the original spherical shape M0 of the Simplex Mesh Model in order to map it onto the object of interest C, that is to make its surface as close as possible to the surface of the object of interest C. This operation is performed by iterative steps according to the iterative law taught by the cited publication. This law permits of establishing a balance between external forces that are first forces of traction of the cells F0, F1, F2, . . . , of the model towards the surface of the object of reference C, i.e. they force the cell surfaces to be close to the object surface; and internal forces that are regularization forces for forcing of the general surface of the Mesh Model to be smooth.

4) Estimation of the Fitness of the Mapping Operation.

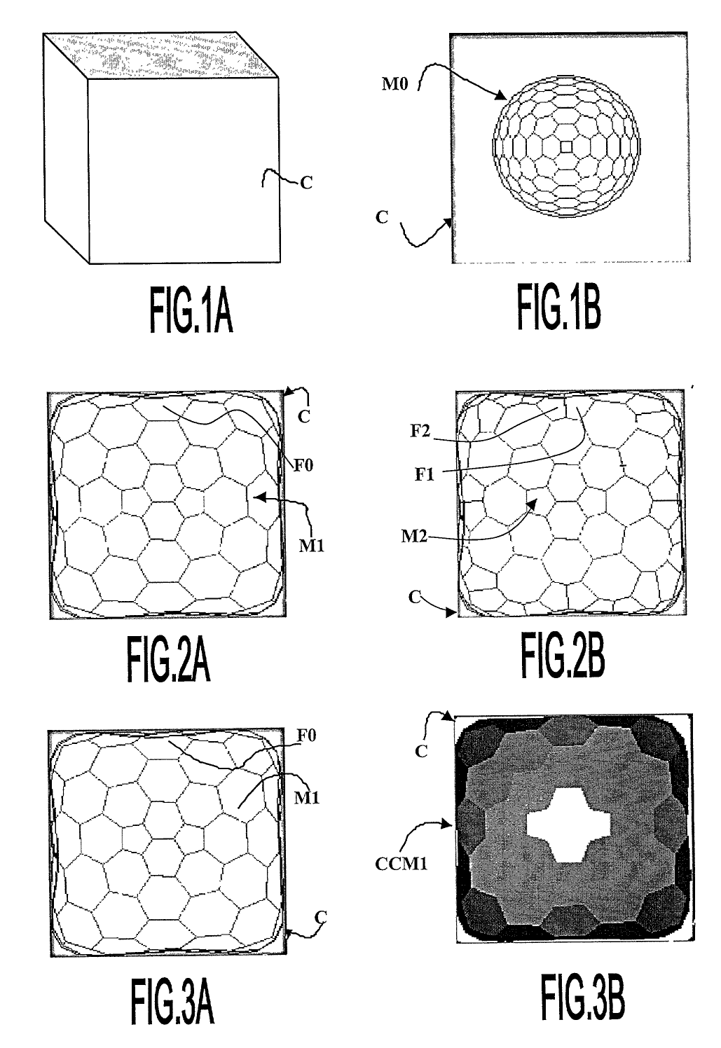

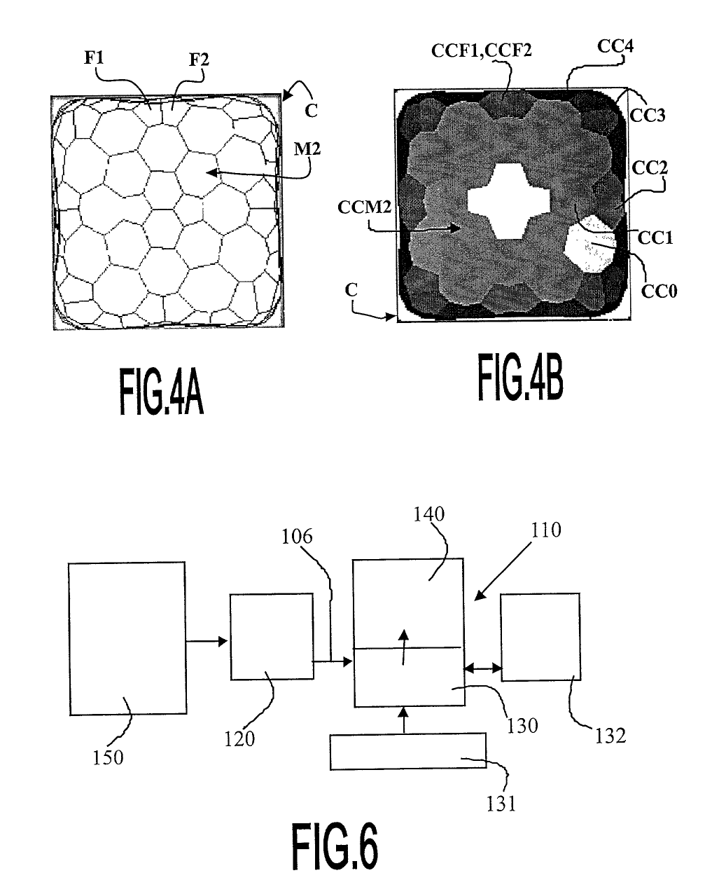

FIG. 2A and FIG. 3A represent the Mesh Model M0 that is deformed after a given number of iterative steps performed according to the above-cited iterative law. The new shape of the Mesh Model in this phase is denoted M1. The surfaces of the cells of the initial Mesh Model M0 are attracted by the surface of the object of reference C by the action of the external forces, while the internal forces smooth the Mesh Model surface, in such a manner that the shape of the Mesh Model M1 is nearer and nearer of the shape of the object of reference. The user may evaluate the fitness of the new shape of the Mesh Model M1 with respect to the shape of the object of reference C, only by displaying the superimposed images of said object C and said Mesh Model M1. Moreover, as C is a dense image, visual assessment can usually only be performed from series of 2D slices. So, a quantified estimation is needed in order to better and quicker appreciate said fitness. The present method proposes an automated technique for providing a visual quantification of said fitness in 3D.

The automated technique of estimation of the fitness comprises sub-steps of:

4.1) Constructing a Color Coding Table wherein predetermined colors are associated with given gradient flow values or with given measure levels derived of the intensity gradient denoted by “derived measure levels”. For example, possible different derived measures are based on:

statistics on the distribution of the gradient vectors at the location of a cell;

or the orientation of the gradient vectors and not their lengths;

or a power function of the gradient vectors; etc. . . .

A predetermined color may be associated to one gradient flow value or to one derived measure level; or to a set of gradient flow values or to a set of derived measure levels, respectively in a range of gradient flow values or in a range of derived measure levels; colors may be classified in classes of colors, each class of colors corresponding to a range of gradient flow values or to a range of derived measure levels; each class of color may further be sub-divided according to a scale of hues for sub-dividing the range of gradient flow values or the range of derived measure levels;

4.2) Estimating the flow value of the gradient vector field, referred to as “gradient flow value”, or the derived measure level, which passes through the cell surface area of a given cell of the Mesh Model;

4.3) Performing said gradient flow value or derived measure level estimation for a predetermined number of cells of the Mesh Model; this estimation may be performed for all the cells or for a limited number of cells;

4.4) Performing a color coding operation wherein the gradient flow value or derived measure level corresponding to a given cell of the Mesh Model M1 is associated to a color given by the Color Coding Table and wherein said cell is attributed said color determined from the Color Coding Table corresponding to its gradient flow value or derived measure level;

4.5) Displaying the image of the Mesh Model M1 having cells colored according to the color coding operation;

4.6) Assessing the goodness of fitness according to the proportion of cells for which gradient flow value or the derived measure level reaches at least a predetermined level called fitness threshold or to the proportion of cells whose colors are in predetermined scales of colors or hues;

4.7) Taking a decision to refine the process of mapping the Mesh Model onto the object of reference or to stop said process.

The above-described steps 4.2) and 4.3) may be performed before the user actually displays the images of the Mesh Model by performing steps 4.4), 4.5) and 4.6) in order to obtain a visual evaluation of the goodness of fitness and take a decision to further go on with the process or not as in step 4.7).

According to the prior art, the user had to decide by himself whether the fitness was sufficient or not. The goodness of fitness has to be empirically estimating by performing a comparison between the shape of the object of reference and the Mesh Model and by visually estimating the distance between the cells of the Mesh Model and the corresponding zones of the object of reference in 2D slices.

Using the technique of the invention, the user disposes of an automatic quantified estimation of the goodness of fitness of the Mesh Model with respect to the object of interest without to have to perform himself an approximate estimation. The color coded cells of the Mesh Model provide automatically the user with a numerical and visual knowledge of said goodness of fitness. In fact, the gradient flow value, or the derived measure level, related to a given cell gives a representation of likelihood said given cell be close to and aligned with a surface of the object of interest in the 3D image. The greater the gradient flow value or derived measure level related to said cell of the Mesh Model, the better said cell of the Mesh Model locally fits the surface of said object. Using this color coded representation for each cell of the Mesh Model, the user can appreciate easily and rapidly the fitness of each cell.

The theoretical vector field flow computation is performed as follows:

given a vector field \vec{F} and a surface S in a 3-D space, the flow of \vec{F} through S is noted Φ(\vec{F}, S) and equals:

$$Φ ( \vec{F} , S ) = {\int \int }_{S} \vec{F} ( s ) \cdot \vec{n} \cdot ⅆ s \qquad ( 1 )$$

where \vec{n} is the unit normal vector of the elementary surface ds. The following short notation is used:

\vec{ds}=\vec{n}.ds

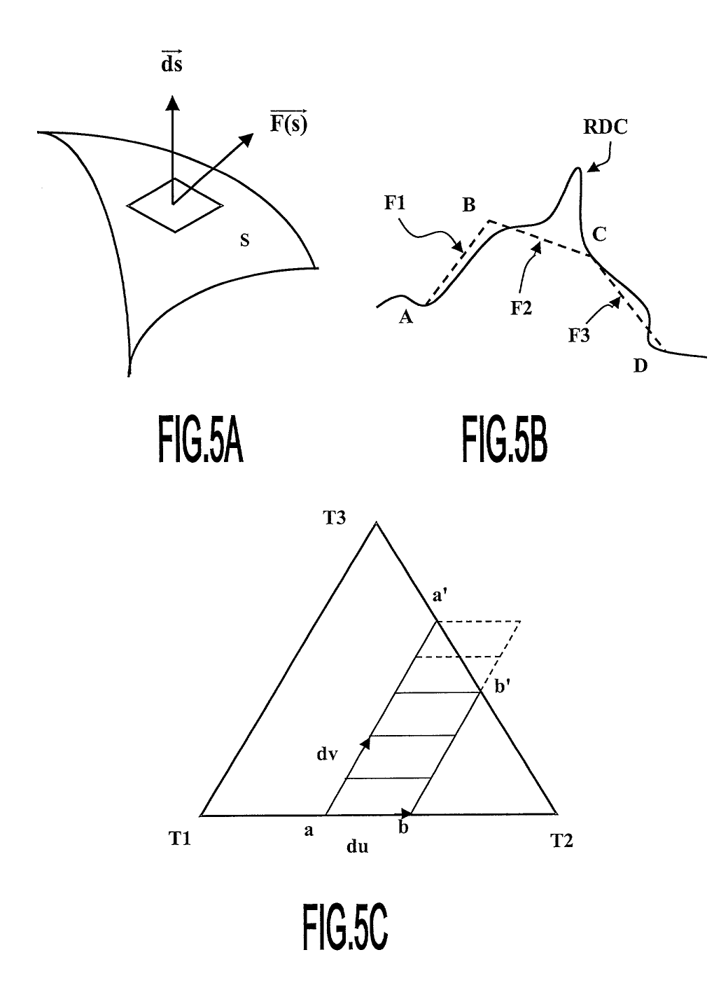

as shown in FIG. 5A, which is a representation of an elementary surface S in the surface S of a curved Cell and of the above-described vectors.

A score related to the gradient flow is calculated. The higher the score the better the confidence of the segmentation. A low score will point out that either the segmentation is bad, meaning that the boundary of the object of reference is far from the Mesh Model or the Cell of the Mesh Model is too large to fit the local configuration of the data related to the object of reference. FIG. 5B shows a 2D representation of a Cell denoted by BC that does not fit the local configuration of the data set. The adjacent Cells denoted respectively by AB and CD are relatively well adapted while BC is too large to follow the local shape of the actual contour of an object of reference denoted by RDC. If the boundary of the object of reference is far from the Mesh Model, the external forces weight may be increased or the local search range for the computation of the external forces weight may be increased. If the cell of the Mesh Model is too large to fit the local configuration of the data related to the object of reference, the cell may be sub-divided into smaller ones. As long as the direct computation of the gradient vector field flow through each cell of the Mesh Model is also proportional to the cell area, the following normalized gradient flow is proposed as the goodness of fitness score:

$${Φ}_{N} ( \vec{F} , S ) = \frac{1}{{\int \int }_{S} ⅆ s} {\int \int }_{S} \vec{∇ F ( s )} \vec{n} ⅆ s \qquad \text{(2A)}$$

where F(s) is the data gray value at position s and \vec{VF(s)} is the 3-D gradient vector computed at position s. As previously defined, derived measures, not only based on the inner product between \vec{V}F(s) and \vec{n}, can be used.

The formulation (2A) may be generalized according to the following formula (2B):

$${Φ}_{N} ( \vec{F} , S ) = \frac{1}{{\int \int }_{S} ⅆ s} {\int \int }_{S} \frac{\vec{∇ F ( s )} \vec{n} ⅆ s}{{‖ ∇ F ‖}^{α}} \qquad \text{(2B)}$$

where α is a coefficient. When α=0, the formula (2B) equals the formula (2A). When α=1, the formula (2B) gives a score only based on the gradient orientation. Different kinds of information may be obtained with 0≦α≦1 which gives intermediary effects of pre-cited examples, or even more generally with α>1.

In the numerical application, the gradient flow is not exactly computed but instead is estimated. The gradient vector for a 3-D position is approximated using a Gaussian derivative method known of those skilled in the art, which has been also used to previously compute the external forces, so no double computations are needed to extract this information related to the gradient vector. In reference to FIG. 5C, an integration along a cell shape is further performed by:

a). dividing the Cell into triangles; each triangle, referred to by nodes T₁, T₂, T₃, is constructed using two adjacent edge points of the Cell; the barycenter of the Cell is also located; so, the Simplex Meshes are transformed into triangular meshes; therefore it is important to notice that the herein described method for visually assessing the goodness of fitting of a Mesh Model onto a 3-D object surface also applies to any Mesh Model whose cells can be decomposed into triangular cells.

b). integrating along the triangles using parallelogram decomposition; a sampling step is chosen in order not to have sub-cells bigger than the known voxel size.

The technique used for the decomposition comprises steps of:

b.1) dividing segment T₁T₂ in an integer number of elementary vectors \vec{du} in order that ∥\vec{du}∥ is directly inferior to the half of the minimum voxel size referred to as minvoxel. So, the number of steps along the T₁T₂ edge equals:

2∥T₁T₂∥/min voxelsize+1 (3)

b.2) for a given du located between a and b, the maximum number of parallelograms that fits in is looked for, meaning that the bb′ interval is divided in order to determine an elementary dv in the same manner as du has been determined from T₁T₂;

b.3) for each parallelogram,

\vec{ds}=\vec{du} [symbol] \vec{dv} (4)

b.4) for each boundary parallelogram, as shown by dashed lined in FIG. 5C, the half value of the area is considered, i.e.

ds=(½) (\vec{du} [symbol] \vec{dv}) (5)

The integration procedure is then a mere summation on elementary surfaces. When dividing the triangle into parallelograms, a track is kept of the total surface of the triangle. A track of the estimated gradient flow or derived measures is also kept by increasing a “Flow” variable with \vec{V}F(s). \vec{ds}. The gradient value for a given point is not interpolated. Instead, the nearest neighbor value is taken. Hence, the normalized computed flow by cell area is given by:

Score=Flow/Area (6)

5) Refining the Fitness of the Matching between the Mesh Model and the Object of Reference.

After a first estimation of the fitness as above-described by performing steps 4.5), 4.6) and 4.7), the user may decide to go on the iterative steps in order to better this fitness.

An option is to freeze the cells that have already reached an acceptable or a predetermined degree of fitness. Freezing cells means that no more calculations are applied to said cells. In particular they are no more divided. Their actual surface area and their distance with respect to the surface of the object of interest do not change anymore. Their goodness of fitness is automatically estimated by the gradient flow value calculations or derived measures and by their color or hue. The decision that the fitness is good is taken in function of said estimation according to the threshold previously described. The frozen cells will have the same color and shape after the further operation of fitness refining.

In the refining operation, the iterative steps are again performed. At each step, the cells are divided by two and the gradient flow is again calculated until the appropriate goodness of fitness is obtained concretized by an appropriate color or range of colors of all the cells of the Mesh Model.

The iterative steps are stopped either when the user decides so by a simple visualization of the color coded image of the resulting Mesh Model or by deciding that the process is automatically stopped when all the cells or a predetermined number of Cells have reached the predetermined threshold.

Referring to FIG. 6, a medical diagnostic imaging apparatus 150 comprises means for acquiring three-dimensional digital image data, and a digital processing system 120 for processing these data according to the processing method described above. The medical examination apparatus comprises means for providing image data to the processing system 120 which has at least one output 106 to provide image data to display and/or storage means 130, 140. The display and storage means may respectively be the screen 140 and the memory of a workstation 110. Said storage means may be alternately external storage means. This image processing system 120 may be a suitably programmed computer of the workstation 130, whose instructions are given by a program product, or a special purpose processor having circuit means such as LUTs, Memories, Filters, Logic Operators, that are arranged to perform the functions of the method steps according to the invention. The workstation 130 may also comprise a keyboard 131 and a mouse 132.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. Image processing method for the segmentation of a three dimensional object in a three dimensional image including an operation of mapping a three dimensional mesh model onto said three dimensional object comprising steps of:
acquiring a tri-dimensional image of an object of interest to be segmented;
generating a mesh model, said mesh model comprising a plurality of cells, the cells having a cell surface area;
deforming the mesh model in order to map said mesh model onto said object of interest;
estimating a gradient flow value or gradient derived measure level of a gradient vector field that passes through the cell surface area of a predetermined number of cells of the mesh model;
assessing a goodness of fitness of the mesh model according to a proportion of cells for which the gradient flow value or gradient derived measure level reaches at least a predetermined level called fitness threshold.

2. The method of claim 1, further comprising steps of:
constructing a color coding table wherein predetermined colors are associated with given gradient flow values or gradient derived measure levels;
associating the gradient flow value or gradient derived measure level of a given cell of the mesh model to a color given by the color coding table corresponding to said gradient flow value or gradient derived measure level.

3. The method of claim 2, further comprising steps of:
performing a color coding operation by attributing to said given cell, the color determined from the color coding table, corresponding to the gradient flow value or gradient derived measure level of said cell;
displaying the image of the mesh model having cells colored according to the color coding operation.

4. The method of claim 3, wherein the color coding operation is performed for all the cells or for a predetermined number of cells.

5. The method of claim 2, wherein in the color coding table, a given color is made in correspondence to a range of gradient flow values or gradient derived measure levels; or to the proportion of cells whose colors are in predetermined scales of colors or hues.

6. The method of claim 2, wherein in the color coding table, a given hue of color is made in correspondence to a subdivision of a range of gradient flow values or gradient derived measure levels.

7. The method of claim 1, further comprising steps of:
stopping the process of mapping the mesh model onto the object of reference as a function of the result of the assessment step.

8. The method of claim 1, further comprising steps of:
refining the process of mapping the mesh model onto the object of reference while a predetermined number of cells of the mesh model or a predetermined proportion of cells of the mesh model has not reached a given level of gradient flow value or gradient derived measure level called threshold and stopping the process when said given range of colors is reached.

9. The method of claim 3, further comprising steps of:
refining the process of mapping the mesh model onto the object of reference while a predetermined number of cells of the mesh model or a predetermined proportion of cells of the mesh model is not displayed in a given range of colors corresponding to a predetermined level of gradient flow value or gradient derived measure level called threshold and stopping the process when said given range of colors is reached.

10. The method of claim 8, wherein the refinement process comprises dividing the cells by two.

11. The method of claim 1, wherein a gradient derived measure is based on statistics on the distribution of the gradient vector field; or the orientation of the gradient vectors and not their lengths; or a power function of the gradient.

12. The method of claim 1, wherein the step of estimating the gradient flow value or gradient derived measure level of the gradient vector field that passes through a cell surface area of the mesh model comprises sub-steps of dividing said cell into triangles and performing an integration along the triangles using parallelogram decomposition for providing said gradient flow value or gradient derived measure level that is proportional to the cell area.

13. An imaging method comprising the steps of:
acquiring a three-dimensional image data set of an object of interest;
generating a mesh model, said mesh model comprising a plurality of cells;
deforming the mesh model whereby said mesh model is mapped to said object of interest;
estimating gradient parameter values from a gradient vector field for a predetermined number of cells of the mesh model; and
determining, for the cells, goodness of fitness values of the mesh model to the object of interest according to the gradient parameter values.

14. The method of claim 13, further comprising the step of:
constructing a color coding table wherein colors are associated with the gradient parameter values.

15. The method of claim 14, further comprising the step of:
displaying the image of the mesh model having the cells colored according to the color coding operation.

16. The method of claim 13, further comprising the step of:
refining the mesh model, the step of refining comprising repeating the steps of deforming the mesh model, estimating gradient parameter values, and determining goodness of fitness values until the goodness of fitness values reach satisfactory values.

17. The method of claim 16, wherein the step of refining further comprises the step of dividing at least one of the plurality of cells into at least two cells.

18. The method of claim 13, wherein the gradient parameter is a gradient flow value.

19. The method of claim 13 wherein the gradient parameter value is a gradient derived measure.

20. The method of claim 13, wherein the step of estimating the gradient parameter values comprises the steps of:
dividing said cells into triangles; and
integrating along the triangles using parallelogram decomposition for providing said gradient parameter values that are proportional to areas of the cells.

21. A medical diagnostic imaging apparatus comprising:
data acquisition means to acquire a three-dimensional image data set of a region of interest of a body;
mesh model generating means for generating a mesh model, said mesh model comprising a plurality of cells;
deformation means for deforming the mesh model whereby said mesh model is mapped to the region of interest;
estimation means for estimating gradient parameter values from a gradient vector field for a predetermined number of cells of the mesh model; and
assessment means for assessing goodness of fitness values of the mesh model according to the gradient parameter values.
